(19) United States
(12) Patent Application Publication
(10) Pub. No.: US 2026/0235719 A1
(43) Pub. Date: Aug. 13, 2026

(54) HEADING ESTIMATION BASED ON AUDIO CUES

(71) Applicant: Apple Inc., Cupertino, CA (US)

(72) Inventor: Andrew Muehlhausen, Seattle, WA (US)

(21) Appl. No.: 19/460,619

(22) Filed: Jan. 27, 2026

Related U.S. Application Data
(60) Provisional application No. 63/756,439, filed on Feb. 10, 2025.

(51) Int. Cl. G01S 5/20; G06T 19/00; H04R 1/40; H04R 3/00

(52) U.S. Cl. CPC G01S 5/20; G06T 19/006; H04R 1/406; H04R 3/005

(57) ABSTRACT

In one implementation, a method of estimating a heading of a device is performed by a device including a first microphone, a second microphone, one or more processors, and non-transitory memory. The method includes obtaining, from the first microphone, first audio data and, from the second microphone, second audio data. The method includes detecting, within the first audio data and the second audio data, a sound generated by a sound source in a physical environment. The method includes determining an internal direction from the device to the sound source in an internal coordinate system of the device based on a difference in a characteristic of the sound detected within the first audio data and the second audio data. The method includes determining a sound source location of the sound source in an external coordinate system of the physical environment. The method includes estimating a heading of the device in the external coordinate system based on the internal direction and the sound source location.

### CROSS-REFERENCES TO RELATED APPLICATIONS

This application claims priority to U.S. Provisional Patent App. No. 63/756,439, filed on Feb. 10, 2025, which is hereby incorporated by reference in its entirety.

### TECHNICAL FIELD

The present disclosure generally relates to systems, methods, and devices of localizing an electronic device based on audio cues detected by the electronic device.

### BACKGROUND

In various implementations, while presenting an extended (XR) reality experience, virtual content presented by a device is dependent on the location and orientation of the device in a physical environment, e.g., the real world. In various implementations, GPS-based localization and magnetometer-based orientation provides insufficient accuracy for all use cases. Accordingly, more accurate methods and devices for determining the location and orientation of a device may be desirable.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIG. 2 illustrates an XR environment in accordance with some implementations.

FIG. 3 illustrates a plot of a direction of an audio source relative to an electronic device over time.

FIG. 4 is a flowchart representation of a method of determining a heading in accordance with some implementations.

FIG. 5 is a block diagram of an example controller in accordance with some implementations.

FIG. 6 is a block diagram of an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for estimating a heading of a device. In various implementations, the method is performed by a device having a first microphone, a second microphone, one or more processors, and non-transitory memory. The method includes obtaining, from the first microphone, first audio data and, from the second microphone, second audio data. The method includes detecting, within the first audio data and the second audio data, a sound generated by a sound source in a physical environment. The method includes determining an internal direction from the device to the sound source in an internal coordinate system of the device based on a difference in a characteristic of the sound detected within the first audio data and the second audio data. The method includes determining a sound source location of the sound source in an external coordinate system of the physical environment. The method includes estimating a heading of the device in the external coordinate system based on the internal direction and the sound source location.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

As noted above, determining the pose (e.g., location and orientation) of a device in the real world using a GPS-based system and a magnetometer-based system may not be accurate enough for XR applications. Accordingly, in various implementations, the accuracy in estimating the pose of a device is enhanced by detecting audio from sources with known locations.

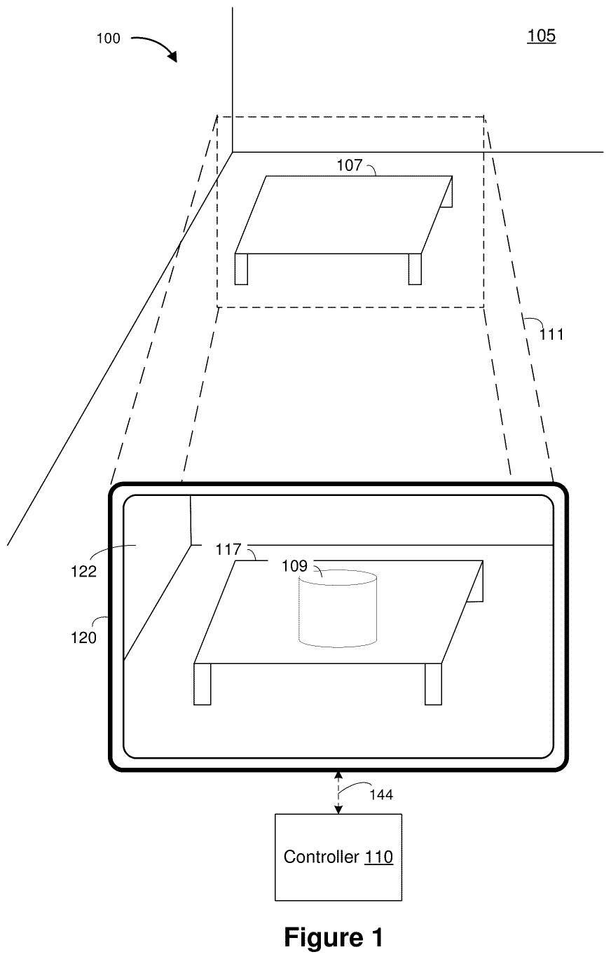

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

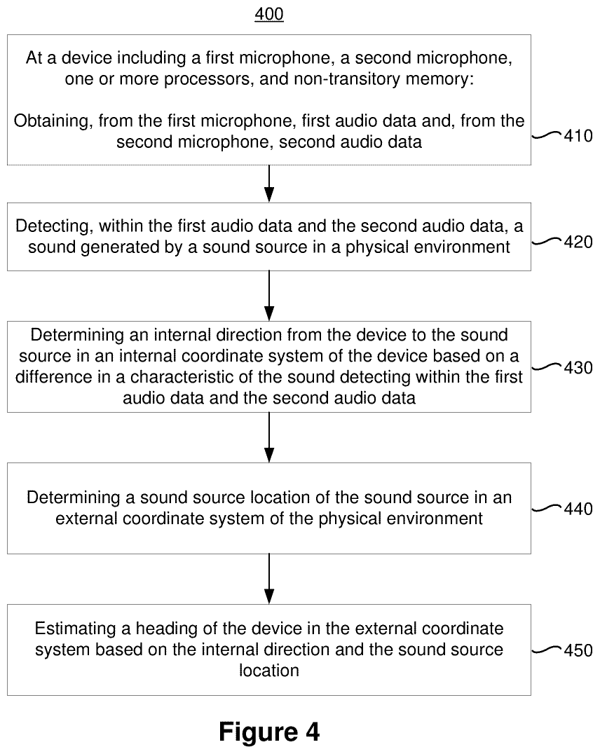

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 4. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

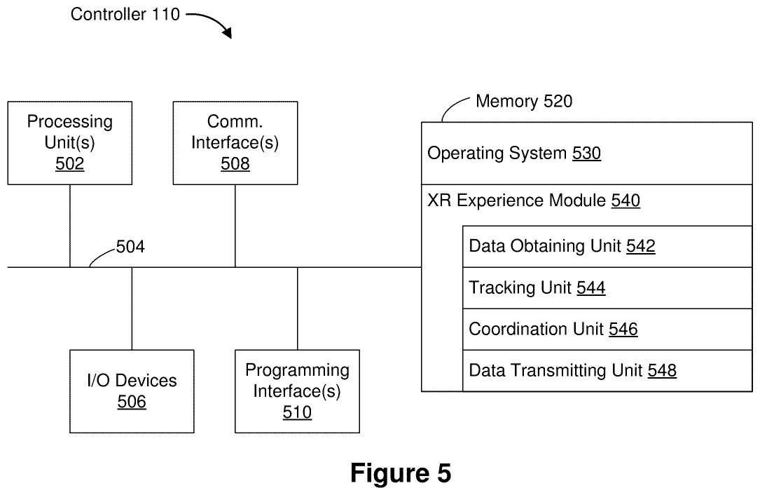

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is virtually or physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR cylinder 109) and to enable video pass-through of the physical environment 105 (e.g., including a representation 117 of the table 107) on a display 122. The electronic device 120 is described in greater detail below with respect to FIG. 5.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

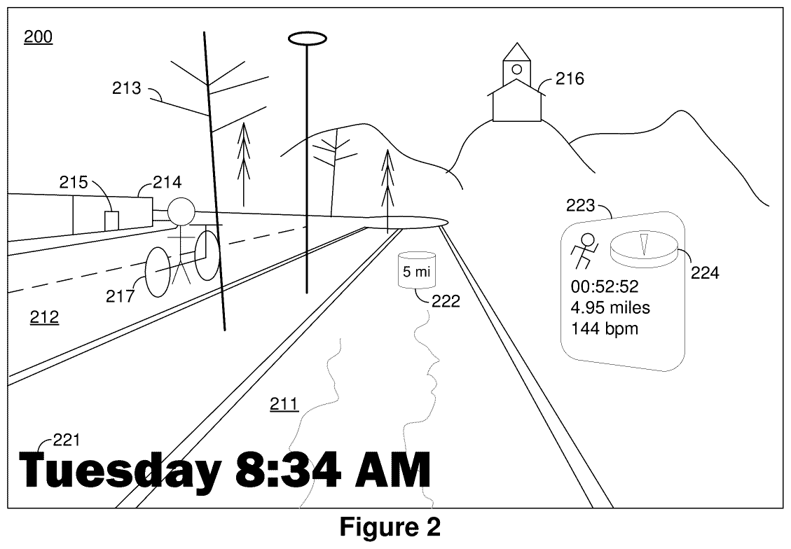

FIG. 2 illustrates an XR environment 200 presented, at least in part, by a display of an electronic device, such as the electronic device 120 of FIG. 1. The XR environment 200 is based on a physical environment of a street at which the electronic device is present.

The XR environment 200 includes a plurality of objects, including one or more physical objects (e.g., a sidewalk 211, a road 212, a tree 213, a building 214 with a door 215, a belltower 216, and a motorcycle 217 moving along the road 212) of the physical environment and one or more virtual objects (e.g., a virtual clock 221, a virtual mile marker 222, and a virtual running application window 223). In various implementations, certain objects (such as the physical objects and the virtual mile marker 222) are presented at a location in the XR environment 200, e.g., at a location defined by three coordinates in a three-dimensional (3D) XR coordinate system such that while some objects may exist in the physical world and the others may not, a spatial relationship (e.g., distance or orientation) may be defined between them. Accordingly, when the electronic device moves in the XR environment 200 (e.g., changes either position and/or orientation), the objects are moved on the display of the electronic device, but retain their location in the XR environment 200. Such virtual objects that, in response to motion of the electronic device, move on the display, but retain their position in the XR environment 200 are referred to as world-locked objects.

In various implementations, certain virtual objects (such as the virtual clock 221) are displayed at locations on the display such that when the electronic device moves in the XR environment 200, the objects are stationary on the display on the electronic device. Such virtual objects that, in response to motion of the electronic device, retain their location on the display are referred to as display-locked objects.

In various implementations, the location in the XR environment 200 of certain virtual objects (such as the virtual running application window 223) changes based on the pose of the body of the user. Such virtual objects are referred to as body-locked objects. For example, as the user runs, the virtual running application window 223 maintains a location approximately one meter in front and half a meter to the right of the user (e.g., relative to the position and orientation of the user's torso). As the head of the user moves, without the body of the user moving, the virtual running application window 223 appears at a fixed location in the XR environment 200.

In order to determine the location on the display of the world-locked and body-locked virtual objects, the electronic device determines the pose of the device in the physical environment. The pose (e.g., location and orientation) of the electronic device in the physical environment can be defined by six values, three values defining the three-dimensional location of the electronic device (translation) and three values defining the orientation of the electronic device at the three-dimensional location (rotation).

The location of the electronic device is defined by three coordinates in an external three-dimensional coordinate system. In various implementations, the external three-dimensional coordinate system includes three axes: an E-axis that is positive along an east direction, an N-axis that is positive along a north direction, and a U-axis that is positive in an up direction, e.g., in the direction opposite gravity. Thus, in various implementations, the location of the electronic device is defined by an E-coordinate, an N-coordinate, and a U-coordinate.

The orientation of the electronic device is defined by three angles: a heading (corresponding to rotation about the U-axis) which changes when a user of the electronic device turns his or her head to the left or right, a pitch which changes when the user moves his or head to look up or down, and a roll which changes when the user tilts his or her head (e.g., bringing the ear closer to or further from the shoulder). Thus, the orientation of the electronic device is defined by a heading, a pitch, and a roll.

Accordingly, estimating the pose of the electronic device is a 6-dof (degrees of freedom) estimation problem. However, an estimate of a gravity vector (e.g., using an inertial sensor, accelerometer, or visual inertial odometry (VIO)) provides estimates of the pitch and roll, reducing the estimation problem to 4-dof estimation problem. Further, an estimate of location (e.g., from a Global Positioning System (GPS) sensor) provides an estimate of the E-coordinate, N-coordinate, and U-coordinate, reducing the estimation problem to a 1-dof estimation problem in which the heading remains to be estimated.

In various implementations, the electronic device has an internal three-dimensional coordinate system that does not change as the electronic device is moved in the physical environment. In various implementations, the electronic device stores (and, as the electronic device moves, updates) a mapping between the internal three-dimensional coordinate system and the external three-dimensional coordinate system. In various implementations, the internal three-dimensional coordinate system includes three axes: a x-axis that is positive towards the right of the display, a y-axis that is positive towards the top of the display, and a z-axis that perpendicular to the x-axis and y-axis (e.g., positive in a depth direction away from the display).

In various implementations, the electronic device determines the heading based on detecting sound from sound sources with known locations. For example, in various implementations, the electronic device detects the sound of bells from the belltower 216. The electronic device determines the direction from the electronic device to the belltower 216 in the internal three-dimensional coordinate system. For example, where 0 degrees is straight ahead, the electronic device determines that direction from the electronic device to the belltower 216 (or the relative bearing of the belltower 216) in the internal three-dimensional coordinate system is 15 degrees. Based on the known location of the electronic device (e.g., using GPS) and the known location of the belltower 216 (e.g., using map data), the electronic device determines a direction from the electronic device to the belltower 216 in the external three-dimensional coordinate system. For example, the electronic device determines that the direction from the electronic device to the belltower 216 (or the absolute bearing of the belltower 216) is 195 degrees. Subtracting the direction in the internal three-dimensional coordinate system from the direction in the external three-dimensional coordinate system gives a heading of the electronic device in the external three-dimensional coordinate system of 180 degrees, or true south.

As another example, in various implementations, the electronic device detects the sound of the door 215 opening or closing. The electronic device determines the direction from the electronic device to the door 215 in the internal three-dimensional coordinate system. For example, the electronic device determines that direction from the electronic device to the door 215 in the internal three-dimensional coordinate system is −45 degrees. Based on the known location of the electronic device (e.g., using GPS) and the known location of the door 215 (e.g., using map data), the electronic device determines a direction from the electronic device to the door 215 in the external three-dimensional coordinate system. For example, the electronic device determines that the direction from the electronic device to the door 215 is 135 degrees. Subtracting the direction in the internal three-dimensional coordinate system from the direction in the external three-dimensional coordinate system gives a heading of the electronic device in the external three-dimensional coordinate system of 180 degrees, or true south.

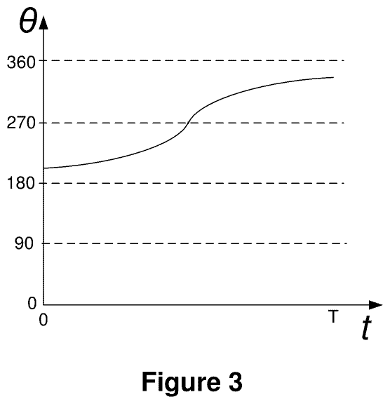

As another example, in various implementations, the electronic device detects the sound of traffic from the road 212, e.g., sound from the motorcycle 217. The location of the motorcycle 217 is neither stationary nor known. However, location of the road 212 is both stationary and known (e.g., from map data). In various implementations, the electronic device determines the direction from the electronic device to the motorcycle 217 in the internal three-dimensional coordinate system over time. FIG. 3 illustrates a plot of the direction of the motorcycle 217 from the electronic device in the internal three-dimensional coordinate system over time. Notably, the curve is an arctangent with a point-of-inflection at 270 degrees.

In various implementations, the electronic device determines the angle value of the inflection point, subtracts 90 degrees and adds the directions of the road 212, here 0 degrees (north) and 180 degrees (south). The ambiguity can be resolved based on localization of the electronic device (e.g., which side of the road 212 the electronic device is on) or localization of the motorcycle (e.g., which side of the road the motorcycle is on relative to the electronic device, either near or far). In various implementations, the inflection point is determined via curve fitting. In various implementations, the inflection point is assumed to be at the point that the sound is loudest. In various implementations, the inflection point is determined based on change in Doppler shift of the sound.

In various implementations, the electronic device displays a virtual compass 224 within the virtual running application window 223 based on the determined heading. Although FIG. 2 illustrates the virtual compass 224 within a body-locked window, in various implementations, the virtual compass is a world-locked virtual object or a display-locked virtual object.

In various implementations, the heading is estimated a number of ways and the estimations are combined to form the determined heading. For example, in various implementations, the heading is estimated based on an inertial measurement unit (IMU). As another example, in various implementations, the heading is estimated based on an image of the physical environment. For example, based on the detected lines in the road 212 and sidewalk 211, a vanishing point can be determined and, based on the known north-south direction of the road 212, a heading of the electronic device in the external three-dimensional coordinate system can be determined.

In various implementations, the electronic device determines the location of a physical object in the internal three-dimensional coordinate system based on detected audio and, based on the known location of the physical object in the external three-dimensional coordinate system, determines the location of the electronic device in the three-dimensional coordinate system.

In various implementations, the location is estimated a number of ways and the estimations are combined to form a determined location. For example, in various implementations, the location is estimated based on GPS data. As another example, in various implementations, the location is estimated based on an image of the physical environment.

FIG. 4 is a flowchart representation of a method 400 of estimating a heading of a device in accordance with some implementations. In various implementations, the method 400 is performed by an electronic device, such as the electronic device 120 of FIG. 1. In various implementations, the method 400 is performed by a device having a plurality of microphones, one or more processors, and non-transitory memory. In some implementations, the method 400 is performed by processing logic, including hardware, firmware, software, or a combination thereof. In some implementations, the method 400 is performed by a processor executing instructions (e.g., code) stored in a non-transitory computer-readable medium (e.g., a memory).

The method 400 begins, in block 410, with the device obtaining, from the first microphone, first audio data and, from the second microphone, second audio data. Although the method 400 is described as being performed with a first microphone and a second microphone, it is to be appreciated that the method 400 can be performed with any number of microphones.

The method 400 continues, in block 420, with the device detecting, within the first audio data and the second audio data, a sound generated by a sound source in a physical environment. For example, in FIG. 2, the electronic device detects the sound of the belltower 216, the sound of the door 215, and the sound of the motorcycle 217. In various implementations, detecting the sound includes detecting sound from a predetermined list of sound sources. For example, in various implementations, detecting the sound includes detecting a vehicle moving along a path. For example, in FIG. 2, the electronic device detects the sound of the motorcycle 217 moving along the road 212. In various implementations, the device detects the sound of a car moving along a road, a bicycle moving along a sidewalk, a train moving along a railroad, or a trolley moving along track. In various implementations, detecting the sound includes detecting a door opening or closing.

The method 400 continues, in block 430, with the device determining an internal direction (or relative bearing) from the device to the sound source in an internal coordinate system of the device based on a difference in a characteristic of the sound detected within the first audio data and the second audio data. In various implementations, the device determines the internal direction in an internal two-dimensional coordinate system or an internal three-dimensional coordinate system. In various implementations, determining the internal direction is based on a difference in timing of the sound within the first audio data and the second audio data. As another example, in various implementations, determining the internal direction is based on a difference in volume of the sound within the first audio data and the second audio data. In general, the device may use any sound source localization algorithm to determine the internal direction. For example, in FIG. 2, the electronic device determines the internal direction from the electronic device to the belltower 216 is 15 degrees.

The method 400 continues, in block 440, with the device determining a sound source location of the sound source in an external coordinate system of the physical environment. In various implementations, the device determines the sound source location in an external two-dimensional coordinate system or an external three-dimensional coordinate system. In various implementations, determining the sound source location includes obtaining map data. In various implementations, determining the sound source location is based on an image of the physical environment.

The method 400 continues, in block 450, with the device estimating a heading of the device in the external coordinate system based on the internal direction and the sound source location. In various implementations, estimating the heading includes determining a device location of the device in the external coordinate system, determining an external direction (or absolute bearing) from the device to the sound source in the external coordinate system based on the device location and the sound source location, and estimating the heading based on the internal direction and the external direction. For example, FIG. 2, the electronic device determines the external direction from the electronic device to the belltower 216 is 195 degrees and estimates the heading by subtracting the internal direction (15 degrees) from the external direction (195 degrees) to estimate a heading of 180 degrees.

As noted above, in various implementations, the estimated heading is used in conjunction with other heading estimation techniques. Accordingly, in various implementations, estimating the heading includes obtaining a first heading estimation of the device based on the internal direction and the sound source location, obtaining a second heading estimation of the device based on an inertial measurement unit or an image of the physical environment, and estimating the heading based on the first heading estimation and the second heading estimation.

In various implementations, the method 400 further includes displaying an indication of the heading. For example, in FIG. 2, the electronic device displays the virtual compass 224 in the virtual running application window 223. In various implementations, the method 400 includes displaying a virtual object at a display location on a display based on the heading. For example, in FIG. 2, the electronic device displays the virtual mile marker 222 at location on the display based on the heading.

FIG. 5 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 502 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 506, one or more communication interfaces 508 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 510, a memory 520, and one or more communication buses 504 for interconnecting these and various other components.

In some implementations, the one or more communication buses 504 include circuitry that interconnects and controls communications between system components. In some implementations, the one or more I/O devices 506 include at least one of a keyboard, a mouse, a touchpad, a joystick, one or more microphones, one or more speakers, one or more image sensors, one or more displays, and/or the like.

The memory 520 includes high-speed random-access memory, such as dynamic random-access memory (DRAM), static random-access memory (SRAM), double-data-rate random-access memory (DDR RAM), or other random-access solid-state memory devices. In some implementations, the memory 520 includes non-volatile memory, such as one or more magnetic disk storage devices, optical disk storage devices, flash memory devices, or other non-volatile solid-state storage devices. The memory 520 optionally includes one or more storage devices remotely located from the one or more processing units 502. The memory 520 comprises a non-transitory computer readable storage medium. In some implementations, the memory 520 or the non-transitory computer readable storage medium of the memory 520 stores the following programs, modules and data structures, or a subset thereof including an optional operating system 530 and an XR experience module 540.

The operating system 530 includes procedures for handling various basic system services and for performing hardware dependent tasks. In some implementations, the XR experience module 540 is configured to manage and coordinate one or more XR experiences for one or more users (e.g., a single XR experience for one or more users, or multiple XR experiences for respective groups of one or more users). To that end, in various implementations, the XR experience module 540 includes a data obtaining unit 542, a tracking unit 544, a coordination unit 546, and a data transmitting unit 548.

In some implementations, the data obtaining unit 542 is configured to obtain data (e.g., presentation data, interaction data, sensor data, location data, etc.) from at least the electronic device 120 of FIG. 1. To that end, in various implementations, the data obtaining unit 542 includes instructions and/or logic therefor, and heuristics and metadata therefor.

In some implementations, the tracking unit 544 is configured to map the physical environment 105 and to track the position/location of at least the electronic device 120 with respect to the physical environment 105 of FIG. 1. To that end, in various implementations, the tracking unit 544 includes instructions and/or logic therefor, and heuristics and metadata therefor.

In some implementations, the coordination unit 546 is configured to manage and coordinate the XR experience presented to the user by the electronic device 120. To that end, in various implementations, the coordination unit 546 includes instructions and/or logic therefor, and heuristics and metadata therefor.

In some implementations, the data transmitting unit 548 is configured to transmit data (e.g., presentation data, location data, etc.) to at least the electronic device 120. To that end, in various implementations, the data transmitting unit 548 includes instructions and/or logic therefor, and heuristics and metadata therefor.

Although the data obtaining unit 542, the tracking unit 544, the coordination unit 546, and the data transmitting unit 548 are shown as residing on a single device (e.g., the controller 110), it should be understood that in other implementations, any combination of the data obtaining unit 542, the tracking unit 544, the coordination unit 546, and the data transmitting unit 548 may be located in separate computing devices.

Moreover, FIG. 5 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 5 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

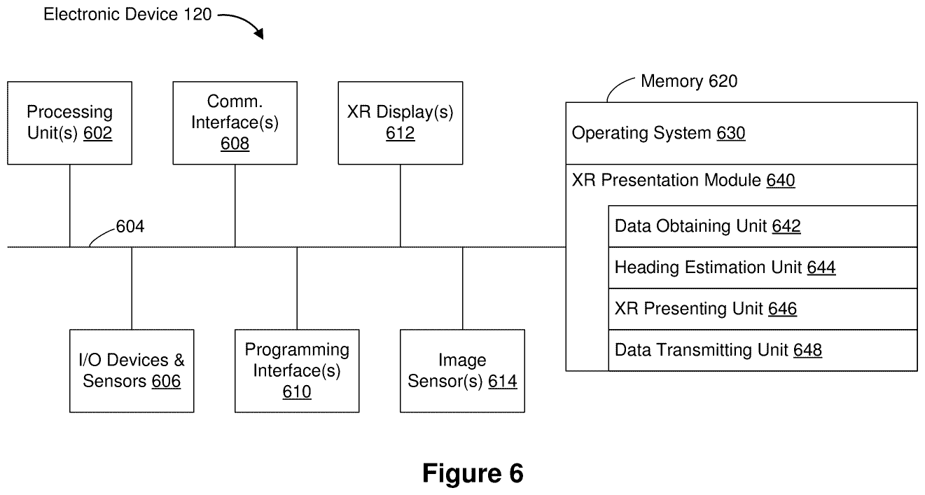

FIG. 6 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 602 (e.g., microprocessors, ASICs, FPGAs, GPUs, CPUs, processing cores, and/or the like), one or more input/output (I/O) devices and sensors 606, one or more communication interfaces 608 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 610, one or more XR displays 612, one or more optional interior-and/or exterior-facing image sensors 614, a memory 620, and one or more communication buses 604 for interconnecting these and various other components.

In some implementations, the one or more communication buses 604 include circuitry that interconnects and controls communications between system components. In some implementations, the one or more I/O devices and sensors 606 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 612 are configured to provide the XR experience to the user. In some implementations, the one or more XR displays 612 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 612 correspond to diffractive, reflective, polarized, holographic, etc. waveguide displays. For example, the electronic device 120 includes a single XR display. In another example, the electronic device includes an XR display for each eye of the user. In some implementations, the one or more XR displays 612 are capable of presenting MR and VR content.

In some implementations, the one or more image sensors 614 are configured to obtain image data that corresponds to at least a portion of the face of the user that includes the eyes of the user (any may be referred to as an eye-tracking camera). In some implementations, the one or more image sensors 614 are configured to be forward-facing so as to obtain image data that corresponds to the physical environment as would be viewed by the user if the electronic device 120 was not present (and may be referred to as a scene camera). The one or more optional image sensors 614 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 620 includes high-speed random-access memory, such as DRAM, SRAM, DDR RAM, or other random-access solid-state memory devices. In some implementations, the memory 620 includes non-volatile memory, such as one or more magnetic disk storage devices, optical disk storage devices, flash memory devices, or other non-volatile solid-state storage devices. The memory 620 optionally includes one or more storage devices remotely located from the one or more processing units 602. The memory 620 comprises a non-transitory computer readable storage medium. In some implementations, the memory 620 or the non-transitory computer readable storage medium of the memory 620 stores the following programs, modules and data structures, or a subset thereof including an optional operating system 630 and an XR presentation module 640.

The operating system 630 includes procedures for handling various basic system services and for performing hardware dependent tasks. In some implementations, the XR presentation module 640 is configured to present XR content to the user via the one or more XR displays 612. To that end, in various implementations, the XR presentation module 640 includes a data obtaining unit 642, a heading estimation unit 644, an XR presenting unit 646, and a data transmitting unit 648.

In some implementations, the data obtaining unit 642 is configured to obtain data (e.g., presentation data, interaction data, sensor data, location data, etc.) from at least the controller 110 of FIG. 1. To that end, in various implementations, the data obtaining unit 642 includes instructions and/or logic therefor, and heuristics and metadata therefor.

In some implementations, the heading estimation unit 644 is configured to estimate a heading of the electronic device 120 based on detected sounds. To that end, in various implementations, the heading estimation unit 644 includes instructions and/or logic therefor, and heuristics and metadata therefor.

In some implementations, the XR presenting unit 646 is configured to display, via the one or more XR displays 612, virtual content based on the estimated heading. To that end, in various implementations, the XR presenting unit 646 includes instructions and/or logic therefor, and heuristics and metadata therefor.

In some implementations, the data transmitting unit 648 is configured to transmit data (e.g., presentation data, location data, etc.) to at least the controller 110. In some implementations, the data transmitting unit 648 is configured to transmit authentication credentials to the electronic device. To that end, in various implementations, the data transmitting unit 648 includes instructions and/or logic therefor, and heuristics and metadata therefor.

Although the data obtaining unit 642, the heading estimation unit 644, the XR presenting unit 646, and the data transmitting unit 648 are shown as residing on a single device (e.g., the electronic device 120), it should be understood that in other implementations, any combination of the data obtaining unit 642, the heading estimation unit 644, the XR presenting unit 646, and the data transmitting unit 648 may be located in separate computing devices.

Moreover, FIG. 6 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 6 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device including a first microphone, a second microphone, non-transitory memory and one or more processors:
obtaining, from the first microphone, first audio data and, from the second microphone, second audio data;
detecting, within the first audio data and the second audio data, a sound generated by a sound source in a physical environment;
determining an internal direction from the device to the sound source in an internal coordinate system of the device based on a difference in a characteristic of the sound detected within the first audio data and the second audio data;
determining a sound source location of the sound source in an external coordinate system of the physical environment; and
estimating a heading of the device in the external coordinate system based on the internal direction and the sound source location.

2. The method of claim 1, wherein detecting the sound includes detecting sound from a predetermined list of sound sources.

3. The method of claim 1, wherein detecting the sound includes detecting a vehicle moving along a path.

4. The method of claim 1, wherein detecting the sound includes detecting a door opening or closing.

5. The method of claim 1, wherein determining the internal direction is based on a difference in timing of the sound within the first audio data and the second audio data.

6. The method of claim 1, wherein determining the internal direction is based on a difference in volume of the sound within the first audio data and the second audio data.

7. The method of claim 1, wherein determining the sound source location includes obtaining map data.

8. The method of claim 1, wherein estimating the heading includes:
determining a device location of the device in the external coordinate system;
determining an external direction from the device to the sound source in the external coordinate system based on the device location and the sound source location; and
estimating the heading based on the internal direction and the external direction.

9. The method of claim 1, wherein estimating the heading includes:
obtaining a first heading estimation of the device based on the internal direction and the sound source location;
obtaining a second heading estimation of the device based on an inertial measurement unit or an image of the physical environment; and
estimating the heading based on the first heading estimation and the second heading estimation.

10. The method of claim 1, further comprising displaying an indication of the heading.

11. The method of claim 1, further comprising displaying a virtual object at a display location on a display based on the heading.

12. A device comprising:
a first microphone;
a second microphone;
a non-transitory memory; and
one or more processors to:
obtain, from the first microphone, first audio data and, from the second microphone, second audio data;
detect, within the first audio data and the second audio data, a sound generated by a sound source in a physical environment;
determine an internal direction from the device to the sound source in an internal coordinate system of the device based on a difference in a characteristic of the sound detected within the first audio data and the second audio data;
determine a sound source location of the sound source in an external coordinate system of the physical environment; and
estimate a heading of the device in the external coordinate system based on the internal direction and the sound source location.

13. The device of claim 12, wherein the one or more processors are to detect the sound by detecting sound from a predetermined list of sound sources.

14. The device of claim 12, wherein the one or more processors are to determine the internal direction based on a difference in timing or volume of the sound within the first audio data and the second audio data.

15. The device of claim 12, wherein the one or more processors are to determine the sound source location by obtaining map data.

16. The device of claim 12, wherein the one or more processors are to estimate the heading by:
determining a device location of the device in the external coordinate system;
determining an external direction from the device to the sound source in the external coordinate system based on the device location and the sound source location; and
estimating the heading based on the internal direction and the external direction.

17. The device of claim 12, wherein the one or more processors are to estimate the heading by:
obtaining a first heading estimation of the device based on the internal direction and the sound source location;
obtaining a second heading estimation of the device based on an inertial measurement unit or an image of the physical environment; and
estimating the heading based on the first heading estimation and the second heading estimation.

18. The device of claim 12, wherein the one or more processors are further to display an indication of the heading.

19. The device of claim 12, wherein the one or more processors are further to display a virtual object at a display location on a display based on the heading.

20. A non-transitory memory storing one or more programs, which, when executed by one or more processors of a device including a first microphone and a second microphone, cause the device to:
obtain, from the first microphone, first audio data and, from the second microphone, second audio data;
detect, within the first audio data and the second audio data, a sound generated by a sound source in a physical environment;
determine an internal direction from the device to the sound source in an internal coordinate system of the device based on a difference in a characteristic of the sound detected within the first audio data and the second audio data;
determine a sound source location of the sound source in an external coordinate system of the physical environment; and
estimate a heading of the device in the external coordinate system based on the internal direction and the sound source location.
